(19) United States
(12) Patent Application Publication
(10) Pub. No.: US 2026/0106869 A1
(43) Pub. Date: Apr. 16, 2026

(54) SYSTEMS AND METHODS FOR AUTOMATICALLY AND DYNAMICALLY UPDATING AND MANAGING AUTHENTICATION CREDENTIAL IN A DISTRIBUTED NETWORK

(71) Applicant: BANK OF AMERICA CORPORATION, CHARLOTTE, NC (US)

(72) Inventors: Naveen Immidisetty, Bordenetown, NJ (US); Kunal Kumar, Newtown, PA (US); Satya Veerabhadra Rao Iruku, Chalfont, PA (US); Bishakha Upadhyaya, Charlotte, NC (US); Abhishek Sharma, Gurugram (IN)

(73) Assignee: BANK OF AMERICA CORPORATION, CHARLOTTE, NC (US)

(21) Appl. No.: 18/916,300

(22) Filed: Oct. 15, 2024

(51) Int. Cl. H04L 9/40

(52) U.S. Cl. CPC H04L 63/0876

(57) ABSTRACT

Systems, computer program products, and methods are described herein for automatically and dynamically updating and managing authentication credentials in a distributed network. The present disclosure is configured to identify at least one vault identifier, wherein the vault identifier is associated with a vault comprising at least one authentication credential; access, based on the at least one vault identifier, vault data for a vault associated with the vault identifier; generate, based on the at least one vault identifier and the vault data, a vault tree comprising a hierarchical organization of the vault and associated vault dependencies comprising at least one shared authentication credential; and configure, based on the vault tree, a vault rotation user interface with the vault tree, wherein the vault rotation user interface comprises the vault tree at a current time with the at least one shared authentication credential.

### TECHNOLOGICAL FIELD

Example embodiments of the present disclosure relate to automatically and dynamically update and manage authentication credentials in a distributed network.

### BACKGROUND

In today's electronic environment, multiple servers may be used to access one website, application, and other such components stored on a server, but many of these servers may also comprise authentication credentials that are needed to access each specific website or application in a secure manner. However, and in order promote a high level of network security, these authentication credentials must be regularly changed and rotated to prevent hackers from accessing the authentication credentials and misappropriating data or electronic communications. The process of rotating these authentication credentials can be manually intensive, time consuming, and difficult to track with respect to all the servers that need to also be updated with the new authentication credentials. Therefore, a need exists for a system to accurately, efficiently, and securely automatically and dynamically update and manage authentication credentials in a distributed network, especially in a distributed environment where a vault of servers and the server dependencies must be updated efficiently to reduce any downtime for accessing these applications or websites.

Applicant has identified a number of deficiencies and problems associated with updating and managing authentication credential in a vault environment, whereby each vault may comprise authentication credentials for a plurality of servers across a distributed network. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for automatically and dynamically updating and managing authentication credentials in a distributed network.

In one aspect, a system for automatically and dynamically updating and managing authentication credential in a distributed network is provided. In some embodiments, the system may comprise: a memory device with computer-readable program code stored thereon; at least one processing device operatively coupled to the at least one memory device and the at least one communication device, wherein executing the computer-readable code is configured to cause the at least one processing device to: identify at least one vault identifier, wherein the vault identifier is associated with a vault comprising at least one authentication credential; access, based on the at least one vault identifier, vault data for a vault associated with the vault identifier; generate, based on the at least one vault identifier and the vault data, a vault tree comprising a hierarchical organization of the vault and associated vault dependencies comprising at least one shared authentication credential; and configure, based on the vault tree, a vault rotation user interface with the vault tree, wherein the vault rotation user interface comprises the vault tree at a current time with the at least one shared authentication credential.

In some embodiments, executing the computer-readable code is configured to cause the at least one processing device to: identify a new authentication credential for the vault tree; and automatically rotate the shared authentication credential with the new authentication credential at the vault and the associated vault dependencies in the vault tree. In some embodiments, the automatic rotation of the shared authentication credential in the associated vault dependencies is based on receiving a sync user input at the vault rotation user interface.

In some embodiments, the vault rotation user interface is integrated with an application programming interface (API).

In some embodiments, the vault rotation user interface is a plugin.

In some embodiments, the identification of the at least one vault identifier further comprises: receiving the vault identifier from a user device, wherein the user device is configured with at least one of the vault rotation user interface or a vault identifier user interface.

In some embodiments, the vault data is accessed automatically by the vault rotation user interface.

In some embodiments, the vault data is accessed by receiving the vault data from a user device.

In some embodiments, executing the computer-readable code is configured to cause the at least one processing device to: receive, by a user device, a security code for the vault identifier; validate the security code with an authenticated security code of the vault identifier; and determine, based on the validation, a user of the user device is allowed access to the vault to rotate the shared authentication credential of the vault. In some embodiments, the determination the user is allowed access to the vault comprises a determination the user is allowed access to view and interact with the vault tree in the vault rotation user interface.

In some embodiments, executing the computer-readable code is configured to cause the at least one processing device to: identify each interaction at the vault rotation user interface and a vault identification user interface, wherein each interaction identified comprises a user account identifier associated with each interaction; and record each interaction in a user interaction database. In some embodiments, executing the computer-readable code is configured to cause the at least one processing device to: determine each interaction is allowed or not allowed for each user account identifier, wherein the determination of each interaction is based on an associated security code for each user account identifier; flag, in an instance where an interaction of the each interaction is not allowed, the interaction; and transmit an alert interface component comprising the flag to a user device associated with the vault rotation user interface.

In some embodiments, the vault identifier is received at a vault identifier user interface, and wherein the vault identifier user interface is a multi-user interface with the vault rotation user interface.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for automatically and dynamically updating and managing authentication credentials in a distributed network, in accordance with an embodiment of the disclosure;

FIG. 2 illustrates a process flow for automatically and dynamically updating and managing authentication credentials in a distributed network, in accordance with an embodiment of the disclosure;

FIG. 3 illustrates a process flow for automatically rotating a shared authentication credential in a vault environment, in accordance with an embodiment of the disclosure;

FIG. 4 illustrates a process flow for determining whether a user associated with a user account and a security code is allowed access to a vault and/or allowed access to the shared authentication credential of the vault, in accordance with an embodiment of the disclosure;

FIG. 5 illustrates a process flow for transmitting an alert interface component to a user device in an instance where a user interaction is flagged, in accordance with an embodiment of the disclosure;

FIG. 6 illustrates an exemplary vault rotation user interface comprising authentication credential data, in accordance with an embodiment of the disclosure;

FIG. 7 illustrates an exemplary vault rotation user interface comprising a vault tree with hierarchical organization of vault dependencies and authentication credential data, in accordance with an embodiment of the disclosure;

FIG. 8 illustrates an exemplary vault rotation user interface comprising vault rotation data, in accordance with an embodiment of the disclosure;

FIG. 9 illustrates an exemplary vault rotation user interface comprising vault rotation data and vault dependency data, in accordance with an embodiment of the disclosure; and

FIG. 10 illustrates an exemplary vault identification user interface comprising vault identifiers and vault rotation data, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In today's electronic environment, multiple servers may be used to access one website, application, and other such components stored on a server, but many of these servers may also comprise authentication credentials that are needed to access each specific website or application in a secure manner. However, and in order promote a high level of network security, these authentication credentials must be regularly changed and rotated to prevent hackers from accessing the authentication credentials and misappropriating data or electronic communications. The process of rotating these authentication credentials can be manually intensive, time consuming, and difficult to track with respect to all of the servers that need to also be updated with the new authentication credentials. Therefore, a need exists for a system to accurately, efficiently, and securely automatically and dynamically update and manage authentication credentials in a distributed network, especially in a distributed environment where a vault of servers and the server dependencies must be updated efficiently to reduce any downtime for accessing these applications or websites.

Accordingly, the present disclosure provides a system, computer program product, and/or a computer implemented method for automatically and dynamically updating and managing authentication credential in a distributed network. By way of example, the system may comprise a memory device with computer-readable program code stored thereon; at least one processing device operatively coupled to the at least one memory device and the at least one communication device, wherein executing the computer-readable code is configured to cause the at least one processing device to: identify at least one vault identifier, wherein the vault identifier is associated with a vault comprising at least one authentication credential; access, based on the at least one vault identifier, vault data for a vault associated with the vault identifier; generate, based on the at least one vault identifier and the vault data, a vault tree comprising a hierarchical organization of the vault and associated vault dependencies comprising at least one shared authentication credential; and configure, based on the vault tree, a vault rotation user interface with the vault tree, wherein the vault rotation user interface comprises the vault tree at a current time with the at least one shared authentication credential. Additionally, the system may further be configured to identify a new authentication credential for the vault tree; and automatically rotate the shared authentication credential with the new authentication credential at the vault and the associated vault dependencies in the vault tree.

In other words, the disclosure provides a system for managing authentication credentials using a program that is configured to access and keep current authentication credentials for each component (e.g., server) within a network and/or associated within a particular security level/group. Thus, and within the program, the program can automatically collect and sort each technical component (e.g., application, sub application, server, processing component, and/or the like) that are both upstream and downstream from each other and that may share the same authentication credential or share the same authentication credential requirements. Using the program and its user friendly interface, a secure access by a particular user may be granted to login to the program, select at least one technical component identifier that needs an authentication credential update, input the new authentication credential, and apply the new authentication credential to the current technical component as well as all the related and downstream technical components.

What is more, the present disclosure provides a technical solution to a technical problem. As described herein, the technical problem includes the updating and managing authentication credential in a vault environment, whereby each vault may comprise authentication credentials for a plurality of servers across a distributed network. The technical solution presented herein allows for the automatic updating and managing of vault environments comprising difficult technical components and their dependent technical components (e.g., applications, servers, and/or the like) and each technical component's authentication credentials in a secure and dynamic environment. In particular, the disclosure provided herein is an improvement over existing solutions to the updating of authentication credentials in a distributed network environment, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

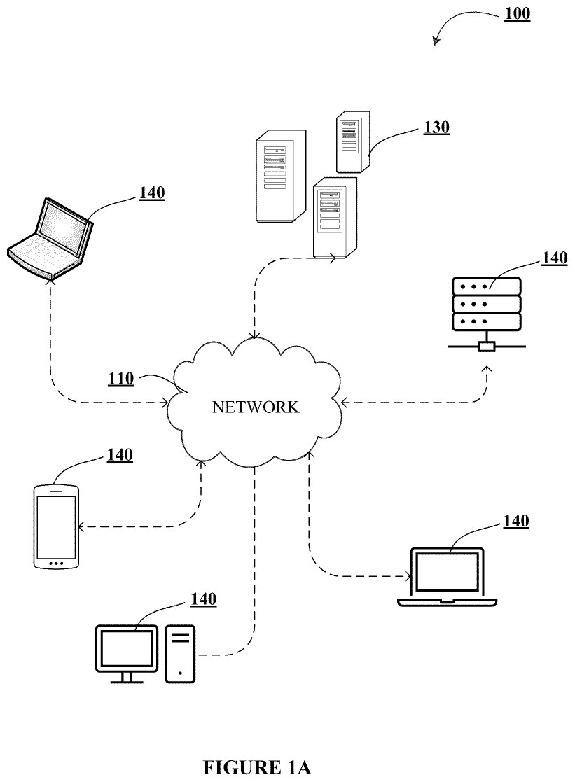

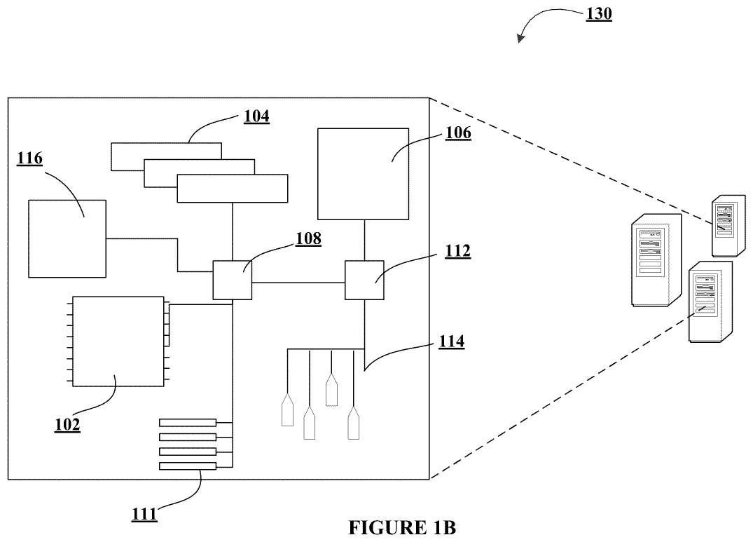

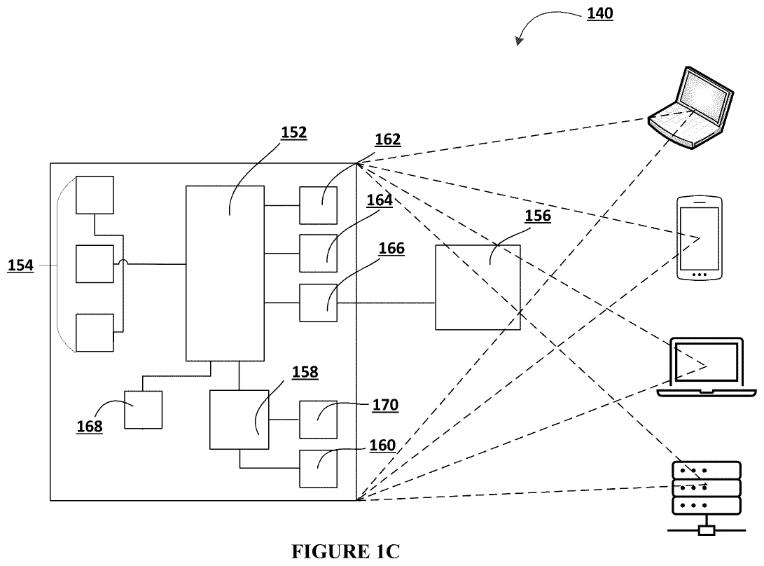

FIGS. 1A-1C illustrate technical components of an exemplary distributed computing environment for automatically and dynamically updating and managing authentication credentials in a distributed network 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

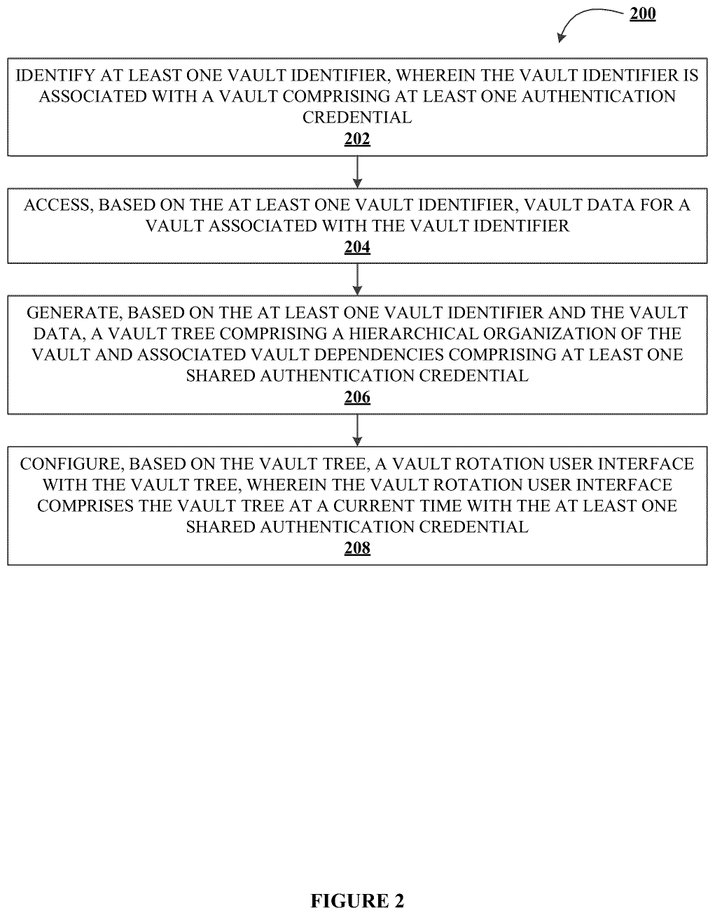

FIG. 2 illustrates a process flow 200 for automatically and dynamically updating and managing authentication credentials in a distributed network, in accordance with an embodiment of the disclosure. In some embodiments, a system (e.g., similar to one or more of the systems described herein with respect to FIGS. 1A-1C) may perform one or more of the steps of process flow 200. For example, a system (e.g., the system 130 described herein with respect to FIG. 1A-1C) may perform the steps of process 200.

As shown in block 202, the process flow 200 may include the step of identifying at least one vault identifier, wherein the vault identifier is associated with a vault comprising at least one authentication credential. For instance, the system may identify at least one vault identifier associated with a vault that stores authentication credentials for one or more technical components (e.g., servers, applications, websites, and/or the like) in a network environment. In some such embodiments, these vaults may comprise data security protocols that require authentication credential rotations that require the regular alteration or change of passwords and other privileged credentials at specified intervals. Such security protocols may be required to prevent the misappropriation of secure data, authentication credentials, man in the middle attacks, hacking, and/or the like, of the data within the vaults or data stored in the vaults that are used to access technical components within a network (e.g., servers, applications, websites, and/or the like).

As used herein, the term “vault” refers to an authentication credential manager or storage component that stores usernames and/or passwords for technical components securely, and in an encrypted format. In some embodiments, a user may access a plurality of authentication credentials associated with their user account (and/or their security allowances or protocols associated with their user account) at one time by inputting a single “principal” authentication credential or password. In some embodiments, the vault may store each dependent technical component's authentication credentials associated with a principal or primary technical component (e.g., an upstream server that receives an authentication credential rotation first, and each of the downstream authentication credentials for each of the downstream technical components may be updated based on the upstream server's authentication credential rotation).

Additionally, and as used herein, a vault identifier uniquely identifies a vault within a network. In some such embodiments, the vault identifier may comprise a unique string of alphanumeric characters which may be generated by the system itself, by a manager of the network/a manager of the vault, a user of the system/a user of the vault, and/or the like. In this manner, and by inputting a vault identifier to the system, such as by a user interacting with a user device that is connected via a network to the system, the system may uniquely identify a particular vault in the network and each of the vault's technical components that the vault stores authentication credentials for. In some embodiments, the vault identifier may be identified by the system by crawling through the network comprising the technical components that need authentication credentials to be rotated (e.g., an expiration of a current authentication credential is imminent).

In some embodiments, and as used herein, the authentication credential term refers to a password, a secure ID, a secure credential, and/or the like. As used herein, the authentication credential is a credential input to a technical component or a vault comprising different authentication credentials for a plurality of technical components, which allows secure access by the inputting user to the technical component(s) such that the user may interact with the technical component, the technical component data, update parameters or security protocols of the technical component(s), and/or the like.

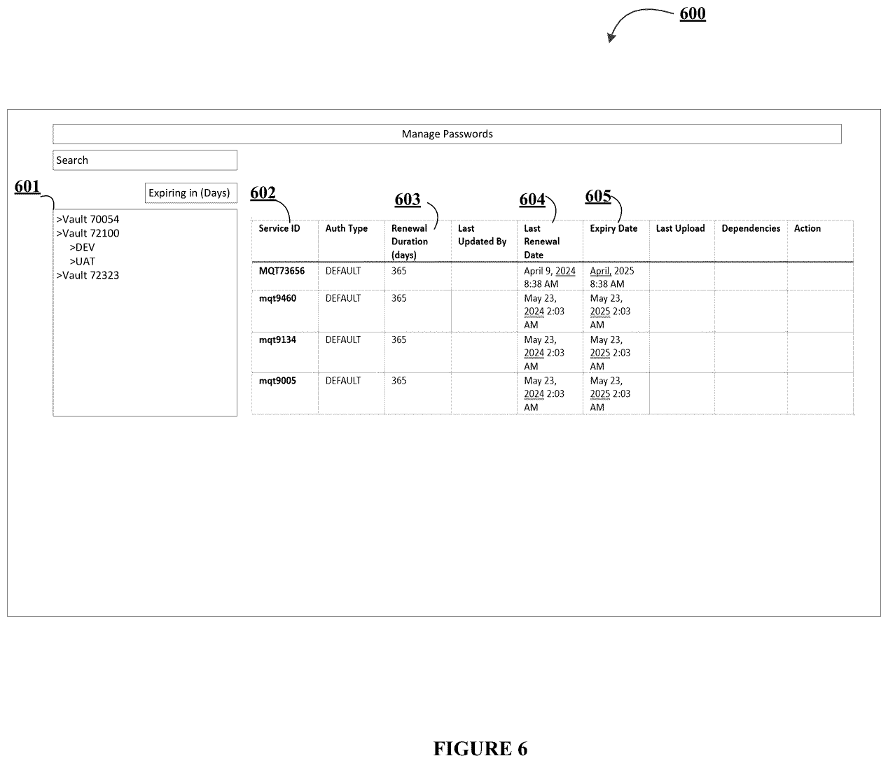

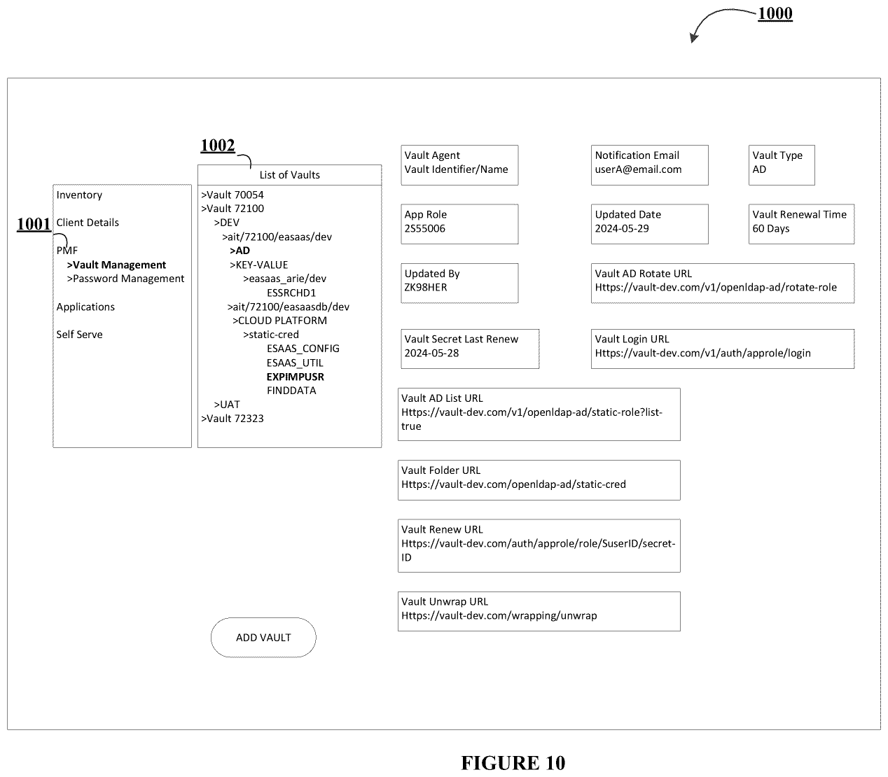

In some embodiments, the step of identifying at least one vault identifier may further comprise a step of receiving the vault identifier from a user device, wherein the user device is configured with at least one of the vault rotation user interface or a vault identifier user interface. For instance, and in some embodiments, the system may identify the at least one vault identifier based on receiving the vault identifier as an input from a user device connected to the system (e.g., connected via a network, such as network 110 of FIG. 1A). For example, and in some such embodiments, a user at the user device may interact with a vault rotation user interface (which is shown as an exemplary graphical user interface in FIGS. 6-9) and/or a vault identifier user interface (which is shown as an exemplary graphical user interface in FIG. 10). In this manner, the user may input and/or select the vault identifier at the vault rotation user interface and/or the user may input and/or select the vault identifier at the vault identifier user interface, and based on the input or selection, the system may configure the graphical user interface of the user device to show the authentication credential data of the vault associated with the vault identifier. In some embodiments, and based on the user inputting the vault identifier to the vault identifier user interface at a first time (e.g., the vault identifier has not previously been identified by the system), the system may crawl through a vault database and/or the vault itself to gather the authentication credential data and fill in the authentication credential data into the user interfaces of the system.

In some embodiments, the vault identifier may be received at a vault identifier user interface, and the vault identifier user interface may be a multi-user interface with the vault rotation user interface. For example, and in some such embodiments, the vault identifier user interface may be coupled with the vault rotation user interface, such that a user may interact with both the vault rotation user interface and the vault identifier user interface as one interactive system between the user interfaces, such that each interaction at one user interface (e.g., a vault identifier user interface) may automatically and dynamically update the other user interface (e.g., the vault rotation user interface, and/or vice versa). In some such embodiments, the vault identifier user interface and the vault rotation user interface may be collaborative user interfaces and, thus allow multiple users to interact with the user interfaces and update authentication credentials in a distributed environment. In some such embodiments, a vault rotation user interface and vault identifier user interface is shown and described in further detail below with respect to FIGS. 6-9 and FIG. 10, respectively.

As shown in block 204, the process flow 200 may include the step of accessing, based on the at least one vault identifier, vault data for a vault associated with the vault identifier. For instance, the system may access vault data based on the identified vault identifier, whereby the vault data comprises the authentication credential data for the vault associated with the vault identifier. In some embodiments, the system may access the vault data from a vault database comprising the current (and in some embodiments, the historical) authentication credentials for each technical component associated with the vault. In some embodiments, the system may automatically crawl through the vault associated with identified vault identifier and gather the current vault data from the vault itself. In some embodiments, the system may use a vault rotation user interface tool (e.g., the tool used to automatically generate the vault rotation user interface) to automatically gather the vault data from the vault associated with the vault identifier. In other words, and in such an embodiment, the vault data may be accessed automatically by the vault rotation user interface. In some embodiments, the vault data may be accessed by receiving the vault data from a user device, where the user interacting with the vault identifier user interface and/or the vault rotation user interface may input the current (and/or historical) authentication credential data for the identified vault.

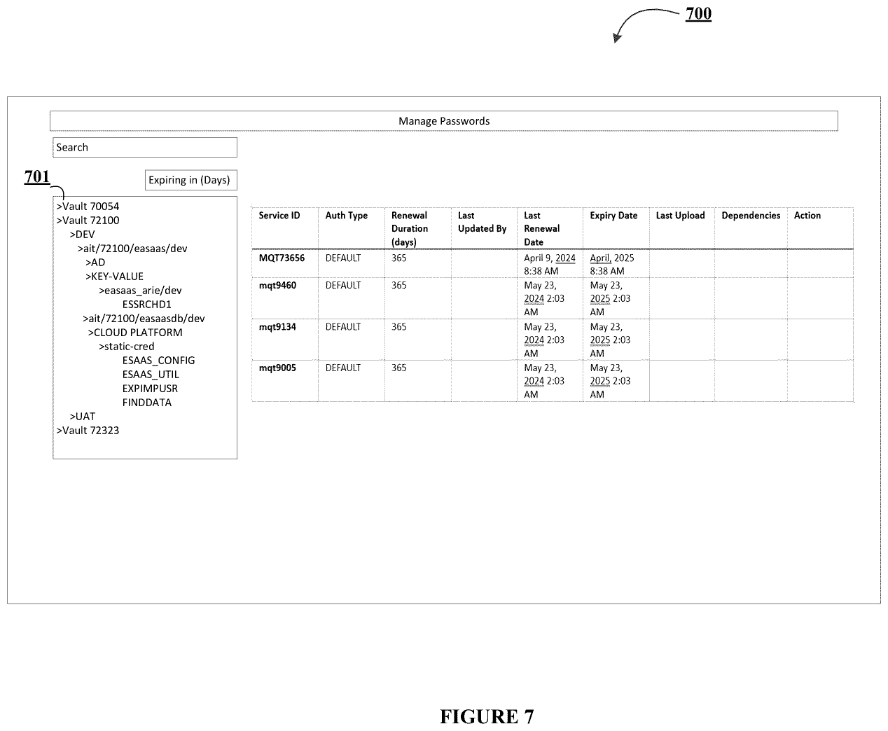

As shown in block 206, the process flow 200 may include the step of generating, based on the at least one vault identifier and the vault data, a vault tree comprising a hierarchical organization of the vault and associated vault dependencies comprising at least one shared authentication credential. For example, the system may generate a vault tree within the system (and as shown in the vault rotation user interface examples in FIGS. 6-9) which comprises the vault identifier identified in block 202, and the vault dependencies for the vault (e.g., the dependent technical components and/or other vaults that may be affected with an authentication credential rotation). In some such embodiments, the vault tree may be generated based on the identified vault data accessed and collected in block 204, whereby the vault data may comprise the current authentication credential data and any vault dependencies for the identified vault. Such a vault tree may be generated to show each of the direct vault dependencies from the identified vault in block 202, and in some embodiments, each of the vault dependencies that are indirect (e.g., once removed or one degree of separation, second removed or second degree of separation, and/or the like). In some such embodiments, the vault tree may be organized as a hierarchical organization of the vault and its vault dependencies, such that each vault dependency is shown underneath each primary vault identifier (e.g., where each upstream vault is organized as the base of the tree and each dependent vault or technical component is organized with a branch of the tree directly connected to the base, and/or directly connected to another branch where the dependent vault or dependent technical component comprises at least one degree of separation from the primary vault at the base). Such a vault tree is shown and described in further detail below with respect to FIGS. 7, 8, and 9.

In some such embodiments, the vault tree may be organized and/or linked with vault dependencies based on the presence of a shared authentication credential between the vault and each of the vault dependencies. For example, and where an authentication credential is required to be rotated in a vault for a technical component and other associated technical components also comprise the same authentication credential (and thus, the same requirement), then the system may link or organize the vault tree to show these vault dependencies between the primary technical component and the dependent technical component(s).

As shown in block 208, the process flow 200 may include the step of configuring, based on the vault tree, a vault rotation user interface with the vault tree, wherein the vault rotation user interface comprises the vault tree at a current time with the at least one shared authentication credential. For instance, the system may configure the vault rotation user interface to show the vault tree and its organized hierarchy of vault dependencies which share at least one authentication credential(s). For example, the system may configure a vault rotation user interface on a user device by generating a vault rotation user interface component which comprises the data of the vault identifier and the vault dependencies, the authentication credential data, and/or the like, as a data packet that is transmissible across a network from the system to the recipient user device and used to automatically trigger the configuration of the user device's graphical user interface (GUI) to show the data of the vault rotation user interface component. In some embodiments, the vault rotation user interface may be configured to show the user of the user device the current authentication credential data of the vault and its vault dependencies, and/or a plurality of vaults and the plurality of the vault's dependencies. Thus, and in some embodiments, the vault rotation user interface may be transmitted to a user device to configure the user device's graphical user interface (GUI). In some embodiments, the vault rotation user interface (and/or the vault identifier user interface) may be configured with an application programming interface (API) or plug-in on a web browser. Such a vault rotation user interface is shown and described below with respect to FIGS. 6-9, and such an example vault identifier user interface is shown and described with respect to FIG. 10.

In some embodiments, the vault rotation user interface may comprise and show the vault tree to the user on the user device as a hierarchical organization of each vault and each vault dependency, such that the user can identify which vaults need to be updated with authentication credential rotations. Further, the vault rotation user interface may comprise the authentication data at the current time for each vault and each vault dependency, such that user can see up-to-date information for each vault and each vault dependency.

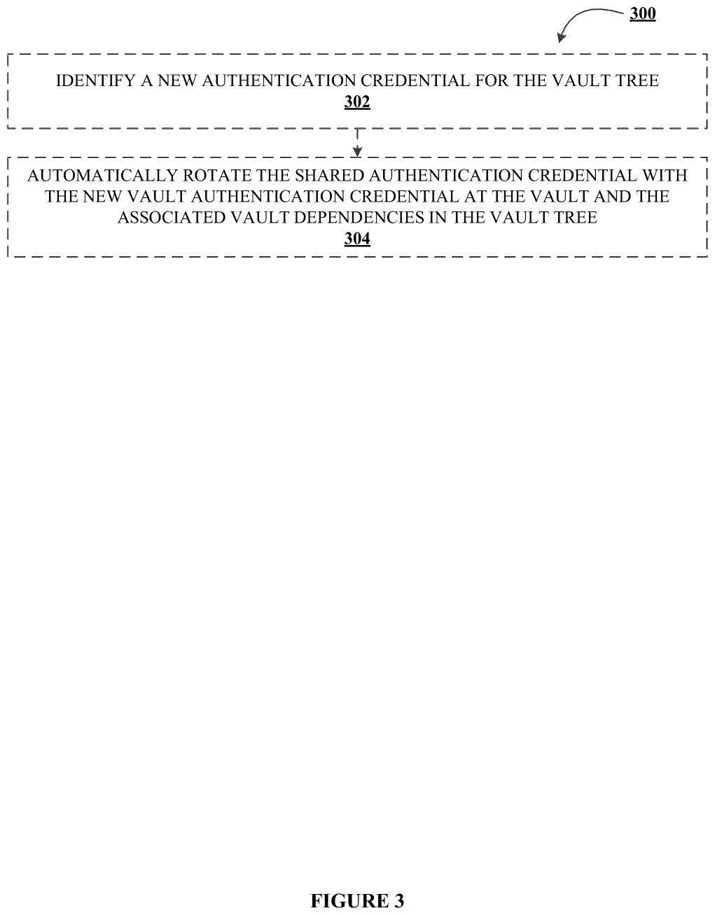

FIG. 3 illustrates a process flow 300 for automatically rotating a shared authentication credential in a vault environment, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300.

In some embodiments, and as shown in block 302, the process flow 300 may include the step of identifying a new authentication credential for the vault tree. For example, and in some such embodiments, the system may identify a new authentication credential for the vault tree, whereby the new authentication credential is the authentication credential that will be rotated to update the current or previous authentication credential for the vault and the vault dependencies. In other words, and by way of example, the new authentication credential is a new password for the vault and/or technical component associated with the vault and the vault dependencies that share the same current password and is affected by the updating of the new password. Thus, and in some embodiments, the system may identify the new authentication credential based on receiving an input from a user at the user device (e.g., the user inputting the new password in the vault rotation user interface for an identified vault or identified technical component), and the user submitting the new authentication credential to the system or automatic rotation. Thus, and in some such embodiments, the new authentication credential may be generated at a user device and transmitted to the system via a network (e.g., via network 110 of FIG. 1A).

In some embodiments, the system itself may generate the new authentication credential and thus, the system may automatically and in real time to generating the new authentication credential identify the new authentication credential for the vault and/or vault dependencies. Thus, and in such embodiments, the new authentication credential may be generated by the system itself, via an automatic authentication credential generation. In some embodiments, the automatic authentication credential generation may analyze each of the historical authentication credentials used for each vault and each vault dependency, and generate a new authentication credential that is brand new as compared to each historical authentication credential. In some embodiments, the authentication credential generation may comprise a random-number generator as part of the new authentication credential(s) generated.

In some embodiments, and as shown in block 304, the process flow 300 may include the step of automatically rotating the shared authentication credential with the new vault authentication credential at the vault and the associated vault dependencies in the vault tree. For instance, and in some such embodiments, the system automatically rotate the shared authentication credential with the new authentication credential throughout the vault dependency(ies) and in near real time or real time to each other. In some embodiments, the automatic rotation of the shared authentication credential with the new vault authentication credential at the vault dependencies may be based on the user selecting or “clicking” a user interface component requesting the user to indicate that the vault dependencies should be synced (e.g., receiving a sync command) with the new authentication credential (e.g., and/or after updating the primary vault's authentication credential). In other words, the automatic rotation of the shared authentication credential in the associated vault dependencies may be based on receiving a sync user input at the vault rotation user interface. In some embodiments, the automatic rotation of the shared authentication credential with the new vault authentication credential may occur in real time or near real time and automatically after updating the primary vault's authentication credential.

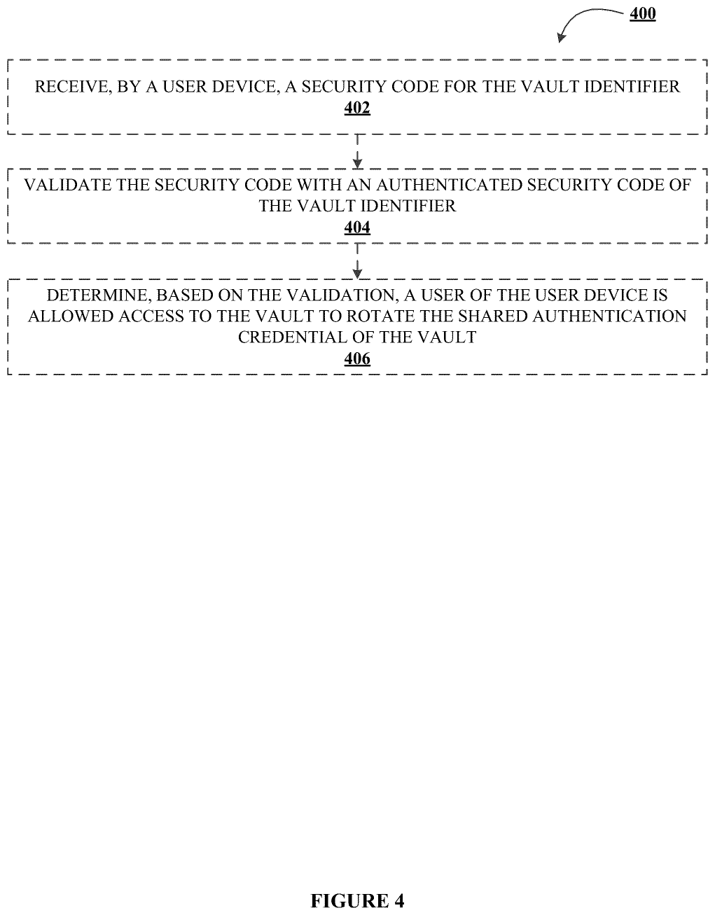

FIG. 4 illustrates a process flow 400 for determining whether a user associated with a user account and a security code is allowed access to a vault and/or allowed access to the shared authentication credential of the vault, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400.

In some embodiments, and as shown in block 402, the process flow 400 may include the step of receiving, by a user device, a security code for the vault identifier. For example, and in some such embodiments, the system may receive a security code for the vault identifier, whereby the security code may be associated with the user account associated with the user device and the user may input the security code which indicates the level of security access the user is allowed. For instance, the security code may comprise an identifier of each of the vaults and/or technical components the user is allowed to access based on security protocols for the vaults and/or technical components. In some embodiments, the security code may be input by the user as a separate authentication credential at the vault identifier user interface and/or the vault rotation user interface, and/or the system may identify the security code based on an attribute within the user account (e.g., a high security access code may allow the user of the user account to access most or all of the vaults and/or technical components in the network, a mid-level security access code may allow the user of the user account to access half of the vaults and/or technical components in the network, a low security access code may allow the user of the user account to access a small number of the vaults and/or technical components in the network, and/or the like). Thus, and in some such embodiments, the system may identify the security code and the security access level of the user account for the user interacting with the user interfaces of the system.

In some embodiments, and as shown in block 404, the process flow 400 may include the step of validating the security code with an authenticated security code of the vault identifier. By way of example, and in some embodiments, when a user inputs the security code, the system may validate the security code received against an authenticated security code of the vault identifier, where each vault the user interacts with via the user interfaces of the system, the system may determine if the user can or should access the vault and its vault data. For example, each vault may comprise its own authenticated security code (e.g., a mid-level authenticated security code of the vault associated with the vault identifier may allow those users with a mid-level or high security code to access the vault and its vault data). Thus, and in some such embodiments, the system may in real time and proactively determine whether a user is allowed to access a vault and its vault data based on comparing the security code of the user account (e.g., which may have been input by the user or collected by the system from the user account data) to the authenticated security code of the vault identifier. Thus, and in this manner, the system may only allow the users that should be allowed access to the vault to access, view, and interact with the vault and its vault data (e.g., authentication credentials, and/or the like) and may automatically block or deny access to any users that are associated with security codes (e.g., security codes input or collected by the system) that do not meet or exceed the authenticated security codes for a vault.

In some embodiments, and as shown in block 406, the process flow 400 may include the step of determining, based on the validation, a user of the user device is allowed access to the vault to rotate the shared authentication credential of the vault. For example, the system may determine a user of the user device interacting with the user interfaces of the system (i.e., the vault identifier user interface and the vault rotation user interface) is allowed access to the vault the user is attempting to access in the user interfaces of the system. For instance, and as a user is selecting vault identifiers within the vault rotation user interface to access and view current vault data (e.g., current authentication credentials and/or the like), then the system may determine, in real time or near real time, whether to automatically allow or automatically deny the user from viewing the vault and its vault data in the vault rotation user interface. Thus, and in some such embodiments, when the security code of the user account is validated against the authenticated security code, then the system may allow the user to access the vault and its vault data (e.g., vault dependencies, authentication credential data, and/or the like) at the vault rotation user interface and/or the vault identifier user interface, and update the vault data (e.g., with new vault dependencies and/or new authentication credentials). Thus, and in some embodiments, and in an instance where the interaction is determined as allowed, the system may automatically allow the interaction (e.g., syncing the authentication credentials for the vault dependencies, add a new vault in the vault identifier user interface, and/or the like).

In contrast, and in some embodiments where the security code is not validated against the authenticated security code (e.g., the security code input by the user or collected from the user account data comprises a lower security access level than the authenticated security code for the specific vault identifier), then the system may automatically block the user from accessing or viewing the vault identifier, the vault data, the authentication credential data, and/or the like. Such an automatic block of the vault identifier and vault data may further comprise the automatic blocking of any vault dependencies and their data.

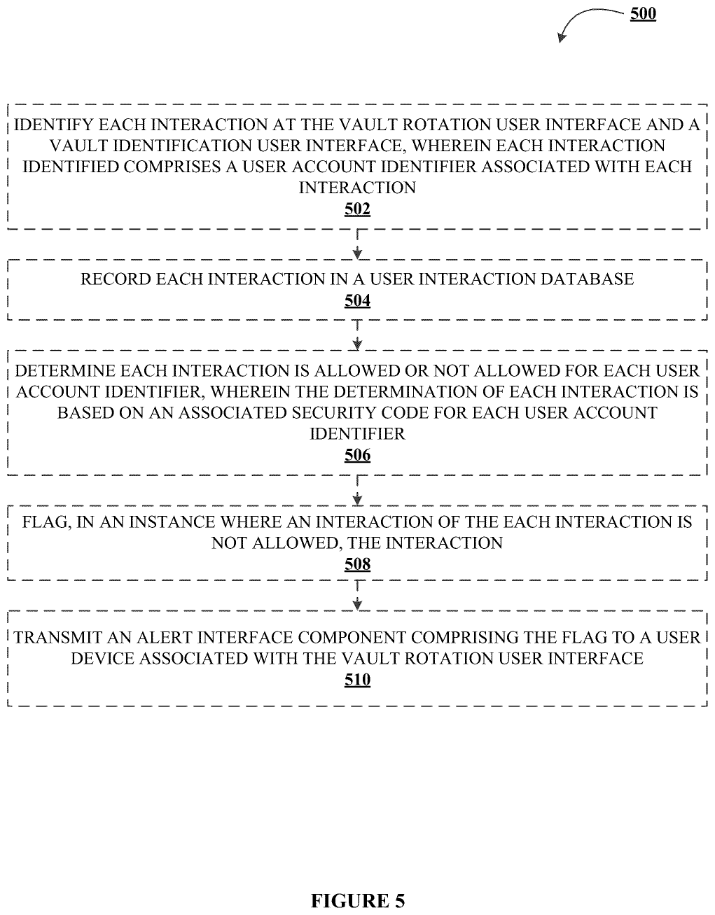

FIG. 5 illustrates a process flow 500 for transmitting an alert interface component to a user device in an instance where a user interaction is flagged, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500.

In some embodiments, and as shown in block 502, the process flow 500 may include the step of identifying each interaction at the vault rotation user interface and a vault identification user interface, wherein each interaction identified comprises a user account identifier associated with each interaction. For instance, and in some such embodiments, the system may identify each interaction of the user at the user interfaces of the system (the vault rotation user interface and/or the user identifier user interfaces), as the user selects, inputs, and/or “clicks” on the user interfaces during each user session. In some embodiments, the system may collect each interaction in a user interaction database, and each interaction may be tracked based on each change, update, keyboard input, click, and/or the like at each user interface described herein. Further, and each interaction identified by the system may further comprise the user account identifier associated with the current user session (e.g., the user account identifier may be collected based on an initial authentication credential/username or password input by the user when the user session has started). In this manner, the system may track each user interaction and link each user interaction in the user interaction database with the proper user account identifier that generated each interaction. In some embodiments, the user may be required to login with their authentication credentials before any user interactions are accepted at the user interfaces described herein, and thus, before any interactions are received or input at the user interfaces.

In some embodiments, and as shown in block 504, the process flow 500 may include the step of recording each interaction in a user interaction database. For instance, and in some such embodiments, the system may record each interaction in a user interaction database, and may record each user account identifier associated with each interaction. In some embodiments, the user interaction database may comprise a table comprising each user interaction for a user account identifier, and whether any of the interactions were allowed or not allowed (and were blocked). In some such embodiments, the interactions that were blocked may further comprise a security code identifier or attribute for the user account and an authenticated security code that was compared to the security code of the user and used to block the interaction. In this manner, and in some such embodiments, the user interaction database may comprise a full view or full report of each interaction and the reasons for interactions that were blocked and/or allowed.

In some embodiments, and as shown in block 506, the process flow 500 may include the step of determining each interaction is allowed or not allowed for each user account identifier, wherein the determination of each interaction is based on an associated security code for each user account identifier. For instance, and in some such embodiments, the system may determine each interaction is allowed or not allowed for each user account identifier based on the security code for each user account and for each vault identifier as compared to each authentication security code for each vault identifier. In this manner, the system may determine which interactions should be flagged for further review by a manager and/or operator of the system, and/or flagged for further review by a manager or operator for the vault and its technical components. For example, a manager and/or operator of the system and/or the vault may need to know which users are attempting to access or interact with a vault that the user should not have access to, and what the user was attempting to do when they interacted with the vault in the system and its user interfaces (e.g., was the user attempting to apply a new authentication credential when the user isn't allowed to).

In some embodiments, and as shown in block 508, the process flow 500 may include the step of flagging, in an instance where an interaction of each interaction is not allowed, the interaction. For instance, and in some such embodiments, the system may flag or generate an alert for the manager and/or operator of the system and/or the vault (and its technical components), whereby the flag may comprise the interaction data for the user account identifier and the vault identifier, whereby the interaction data may comprise all the interactions the user attempted despite their security code not being validated against the authentication security code. In some embodiments, the flagging of the interaction may comprise the generation of an alert interface component which may comprise a data packet of the user account identifier, the security code of the user account, the interaction data the user attempted during their user session (which may be limited to only those interactions that were blocked and/or may comprise all the interaction data throughout the user session), and may be transmitted over a network (e.g., Network 110) to a user device associated with the manager or operator of the system and/or the vault (and its technical components).

In some embodiments, and as shown in block 510, the process flow 500 may include the step of transmitting an alert interface component comprising the flag to a user device associated with the vault rotation user interface. For example, and in some such embodiments, the system may transmit the alert interface component comprising the data that was flagged for the interaction (and/or in some embodiments, all the data of the user session comprising the flagged interaction) to a user device associated with a manager and/or operator of the system and/or the vault. In some such embodiments, and upon transmitting the alert interface component, the system may cause an automatic configuration of the recipient user device's GUI to show the data of the alert interface component. In some embodiments, the configuration of the GUI with the alert interface component may comprise a pop-up0 notification of the data of the alert interface component on the user device's GUI. In some embodiments, the recipient user device and the associated user of the user device may be pre-determined by the system, by an owner of the vault and/or technical component(s), by a manager of the system, and/or the like.

FIG. 6 illustrates exemplary vault rotation user interface 600 comprising authentication credential data, in accordance with an embodiment of the disclosure. In some embodiments, a system (e.g., similar to one or more of the systems described herein with respect to FIGS. 1A-1C) may perform one or more of the steps for generating exemplary vault rotation user interface 600. For example, a system (e.g., the system 130 described herein with respect to FIG. 1A-1C) may perform the steps for generating exemplary vault rotation user interface 600.

As shown in exemplary vault rotation user interface 600, a vault tree 601 may comprise a plurality of vaults (e.g., 70054, 72100, 2323), with at least a further drop down of optional vault dependencies (e.g., vault 72100 comprises drop down menus for development (DEV) and User Acceptance Testing (UAT)). The vault rotation user interface 600 may further show a service ID listing all of the service IDs for the selected vault (e.g., where the selected vault may have been Vault 72100), the other such vault data (e.g., renewal duration for each service ID and their associated authentication credentials 603, the last renewal date for the current authentication credentials 604, and the expiry date for the current authentication credentials 605).

FIG. 7 illustrates exemplary vault rotation user interface 700 comprising a vault tree with hierarchical organization of vault dependencies and authentication credential data, in accordance with an embodiment of the disclosure. In some embodiments, a system (e.g., similar to one or more of the systems described herein with respect to FIGS. 1A-1C) may perform one or more of the steps for generating exemplary vault rotation user interface 700. For example, a system (e.g., the system 130 described herein with respect to FIG. 1A-1C) may perform the steps for generating exemplary vault rotation user interface 700.

As shown in exemplary vault rotation user interface 700, a vault tree showing each of the [primary] vaults (e.g., 70054, 72100, and 72323) may further show each of the vault dependencies for a selected vault (e.g., where the selected vault in FIG. 7 is Vault 72100 and the selected update type is Development (DEV), where the vault dependencies may be shown for primary vault 72100 in a drop down menu). A user, interacting with the vault rotation user interface, may select each vault dependency within the list 701 and interact with each of the technical component dependencies and/or the like for each primary vault, while also viewing the authentication credential data for each vault and each vault dependency in the same window.

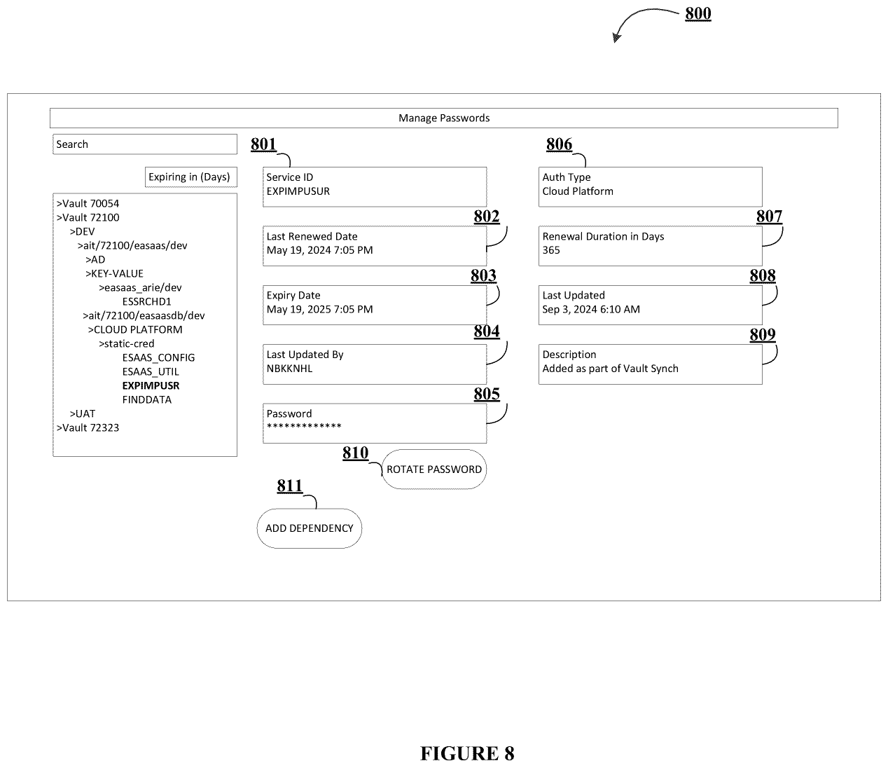

FIG. 8 illustrates exemplary vault rotation user interface 800 comprising vault rotation data, in accordance with an embodiment of the disclosure. In some embodiments, a system (e.g., similar to one or more of the systems described herein with respect to FIGS. 1A-1C) may perform one or more of the steps for generating exemplary vault rotation user interface 800. For example, a system (e.g., the system 130 described herein with respect to FIG. 1A-1C) may perform the steps for generating exemplary vault rotation user interface 800.

As shown in exemplary vault rotation user interface 800, each vault and each vault dependency may be shown in the vault rotation user interface as a user interacts with the vault rotation user interface. For instance, and as shown in exemplary vault rotation user interface 800, the system may show the vault data for each primary vault and each vault dependency as a user interacts with a vault tree. Such vault data my comprise a Service ID 801, a last renewal date of the authentication credential 802, an expiry date for the current authentication credential 803, last updated by data 804, a current authentication credential 805, an authentication type 806 for updating the authentication credential 806, a renewal duration in days for the authentication credential 807, a last updated date 808, a description for why the authentication credential was updated 809, an update password command 810, a dependency add command 811, and/or the like. In some embodiments, the password interface component 805 may be configured to receive the new authentication credential from the user interaction with the vault rotation user interface, and in some such embodiments, the user may select or “click” the rotate password command 810 to update the vault with the new authentication credential.

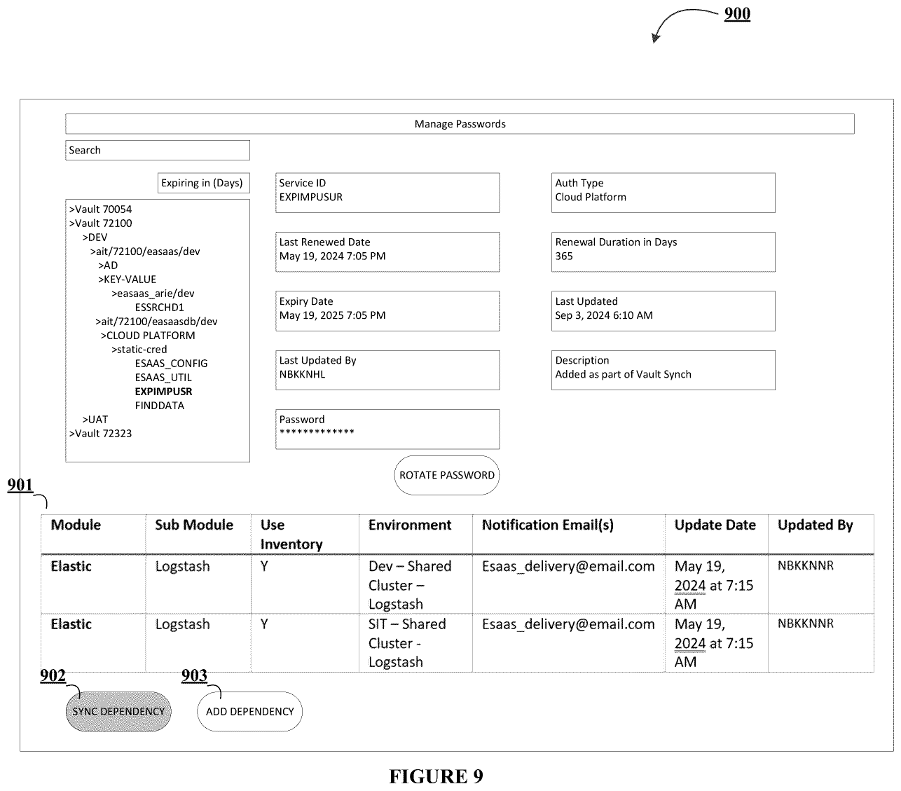

FIG. 9 illustrates exemplary vault rotation user interface 900 comprising vault rotation data, in accordance with an embodiment of the disclosure. In some embodiments, a system (e.g., similar to one or more of the systems described herein with respect to FIGS. 1A-1C) may perform one or more of the steps for generating exemplary vault rotation user interface 900. For example, a system (e.g., the system 130 described herein with respect to FIG. 1A-1C) may perform the steps for generating exemplary vault rotation user interface 900.

As shown in exemplary vault rotation user interface 900, the system may configure the vault rotation user interface with a table of vault dependencies and vault dependency data 901 (e.g., the module the vault dependency is a part of, the submodule, environment the dependency belongs to, who should be notified of any changes to the vault dependency, a last updated date for the authentication credential, and updated by identifier, and/or the like). As shown and described hereinabove, the vault dependencies shown in the vault rotation user interface and/or in the vault tree may comprise other vaults that will be affected by a change or update to an authentication credential in a primary vault, other technical components that will be affected by a change or update to an authentication credential in the primary vault, and/or the like.

Additionally, and as shown in exemplary vault rotation user interface 900, the system may configure the exemplary vault rotation user interface to comprise a sync dependency command 902 (e.g., where once a new authentication credential is input or generated, the system may automatically or upon receiving a sync command, update the current authentication credentials of the vault dependencies with the shared authentication credential with the new authentication credential). In some embodiments, the exemplary vault rotation user interface 900 may comprise an add dependency command 903 (e.g., a user may manually input or request the system to crawl the vault to determine any additional vault dependencies).

FIG. 10 illustrates exemplary vault identifier user interface 1000 comprising vault identifiers and vault rotation data, in accordance with an embodiment of the disclosure. In some embodiments, a system (e.g., similar to one or more of the systems described herein with respect to FIGS. 1A-1C) may perform one or more of the steps for generating exemplary vault identifier user interface 1000. For example, a system (e.g., the system 130 described herein with respect to FIG. 1A-1C) may perform the steps for generating exemplary vault identifier user interface 1000.

As shown in exemplary vault identifier user interface 1000, the system may configure the vault identifier user interface to receive user inputs, including but not limited to, vault identifiers 1002. Additionally, and in some embodiments, the vault identifier user interface 1000 may allow for a user to input a vault identifier by a user first selecting a vault management command 1001 in a password management framework (PMF, e.g., the system described herein which may be part of a larger system and/or may be its own system) selection of the vault identifier user interface 1000. Further, and upon selecting a vault or a vault dependency, the system may populate the vault identifier user interface 1000 to show the vault data (e.g., the vault agent vault identifier/name), the application role, the last updated by identifier, the vault secret last renewal data, vault universal resource locators (URLs), a notification email for the vault, a last updated date, a vault type, a vault renewal time, and/or the like.

Importantly, and as understood by the description provided herein, the vault rotation user interface and the vault identifier user interface may take different formats than those shown and described herein. However, and equally importantly, the interfaces of the system described herein (i.e., the vault rotation user interface and the vault identifier user interface) may also appear universal to a user interacting with the user interfaces despite any changes or updates to an underlying vault, an underlying web browser, and/or the like.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for automatically and dynamically updating and managing authentication credential in a distributed network, the system comprising:
a memory device with computer-readable program code stored thereon;
at least one processing device operatively coupled to the at least one memory device and the at least one communication device, wherein executing the computer-readable code is configured to cause the at least one processing device to:
identify at least one vault identifier, wherein the vault identifier is associated with a vault comprising at least one authentication credential;
access, based on the at least one vault identifier, vault data for a vault associated with the vault identifier;
generate, based on the at least one vault identifier and the vault data, a vault tree comprising a hierarchical organization of the vault and associated vault dependencies comprising at least one shared authentication credential; and
configure, based on the vault tree, a vault rotation user interface with the vault tree, wherein the vault rotation user interface comprises the vault tree at a current time with the at least one shared authentication credential.

2. The system of claim 1, wherein executing the computer-readable code is configured to cause the at least one processing device to:
identify a new authentication credential for the vault tree; and
automatically rotate the shared authentication credential with the new authentication credential at the vault and the associated vault dependencies in the vault tree.

3. The system of claim 2, wherein the automatic rotation of the shared authentication credential in the associated vault dependencies is based on receiving a sync user input at the vault rotation user interface.

4. The system of claim 1, wherein the vault rotation user interface is integrated with an application programming interface (API).

5. The system of claim 1, wherein the vault rotation user interface is a plugin.

6. The system of claim 1, wherein the identification of the at least one vault identifier further comprises:
receiving the vault identifier from a user device, wherein the user device is configured with at least one of the vault rotation user interface or a vault identifier user interface.

7. The system of claim 1, wherein the vault data is accessed automatically by the vault rotation user interface.

8. The system of claim 1, wherein the vault data is accessed by receiving the vault data from a user device.

9. The system of claim 1, wherein executing the computer-readable code is configured to cause the at least one processing device to:
receive, by a user device, a security code for the vault identifier;
validate the security code with an authenticated security code of the vault identifier; and
determine, based on the validation, a user of the user device is allowed access to the vault to rotate the shared authentication credential of the vault.

10. The system of claim 9, wherein the determination the user is allowed access to the vault comprises a determination the user is allowed access to view and interact with the vault tree in the vault rotation user interface.

11. The system of claim 1, wherein executing the computer-readable code is configured to cause the at least one processing device to:
identify each interaction at the vault rotation user interface and a vault identification user interface, wherein each interaction identified comprises a user account identifier associated with each interaction; and
record each interaction in a user interaction database.

12. The system of claim 11, wherein executing the computer-readable code is configured to cause the at least one processing device to:
determine each interaction is allowed or not allowed for each user account identifier, wherein the determination of each interaction is based on an associated security code for each user account identifier;
flag, in an instance where an interaction of the each interaction is not allowed, the interaction; and
transmit an alert interface component comprising the flag to a user device associated with the vault rotation user interface.

13. The system of claim 1, wherein the vault identifier is received at a vault identifier user interface, and wherein the vault identifier user interface is a multi-user interface with the vault rotation user interface.

14. A computer program product for automatically and dynamically updating and managing authentication credential in a distributed network, wherein the computer program product comprises at least one non-transitory computer-readable medium having computer-readable program code portions embodied therein, the computer-readable program code portions which when executed by a processing device are configured to cause the processor to:
identify at least one vault identifier, wherein the vault identifier is associated with a vault comprising at least one authentication credential;
access, based on the at least one vault identifier, vault data for a vault associated with the vault identifier;
generate, based on the at least one vault identifier and the vault data, a vault tree comprising a hierarchical organization of the vault and associated vault dependencies comprising at least one shared authentication credential; and
configure, based on the vault tree, a vault rotation user interface with the vault tree, wherein the vault rotation user interface comprises the vault tree at a current time with the at least one shared authentication credential.

15. The computer program product of claim 14, wherein the computer-readable program code portions which when executed by the processing device are further configured to cause the processor to:
identify a new authentication credential for the vault tree; and
automatically rotate the shared authentication credential with the new authentication credential at the vault and the associated vault dependencies in the vault tree.

16. The computer program product of claim 15, wherein the automatic rotation of the shared authentication credential in the associated vault dependencies is based on receiving a sync user input at the vault rotation user interface.

17. The computer program product of claim 14, wherein the identification of the at least one vault identifier further comprises:
receiving the vault identifier from a user device, wherein the user device is configured with at least one of the vault rotation user interface or a vault identifier user interface.

18. The computer program product of claim 14, wherein the computer-readable program code portions which when executed by the processing device are further configured to cause the processor to:
receive, by a user device, a security code for the vault identifier;
validate the security code with an authenticated security code of the vault identifier; and
determine, based on the validation, a user of the user device is allowed access to the vault to rotate the shared authentication credential of the vault.

19. The computer program product of claim 14, wherein the computer-readable program code portions which when executed by the processing device are further configured to cause the processor to:
identify each interaction at the vault rotation user interface and a vault identification user interface, wherein each interaction identified comprises a user account identifier associated with each interaction; and
record each interaction in a user interaction database.

20. A computer implemented method for automatically and dynamically updating and managing authentication credential in a distributed network, the computer implemented method comprising:
identifying at least one vault identifier, wherein the vault identifier is associated with a vault comprising at least one authentication credential;
accessing, based on the at least one vault identifier, vault data for a vault associated with the vault identifier;
generating, based on the at least one vault identifier and the vault data, a vault tree comprising a hierarchical organization of the vault and associated vault dependencies comprising at least one shared authentication credential; and
configuring, based on the vault tree, a vault rotation user interface with the vault tree, wherein the vault rotation user interface comprises the vault tree at a current time with the at least one shared authentication credential.
